(19) United States
(12) Patent Application Publication
(10) Pub. No.: US 2008/0291188 A1
(43) Pub. Date: Nov. 27, 2008

(54) DRIVING DEVICE AND DRIVING METHOD OF PLASMA DISPLAY PANEL

(76) Inventors: Min Hur, Suwon-si (KR); Soo-ho Park, Suwon-si (KR)

Correspondence Address: CHRISTIE, PARKER & HALE, LLP, PO BOX 7068, PASADENA, CA, 91109-7068, US

(21) Appl. No.: 12/042,267

(22) Filed: Mar. 4, 2008

(30) Foreign Application Priority Data
May 23, 2007 (KR) 10-2007-0050389

(51) Int. Cl. G09G 5/00

(52) U.S. Cl. 345/208

(57) ABSTRACT

A method of driving a plasma display panel including: obtaining a temperature of the plasma display panel; and generating an electrode driving signal, wherein: if the temperature between first and second reference temperatures, generating a first waveform, if the temperature is less than the first reference temperature, generating a second waveform with an absolute value of a peak value being greater than a corresponding peak value of the first waveform, and if the temperature is greater than the second reference temperature, generating a third waveform with an absolute value of a peak value being less than a corresponding peak value of the first waveform; wherein an absolute value of a difference between the peak values of the second and first waveforms is larger than an absolute value of a difference between corresponding peak values of the third and first waveforms.

### CROSS-REFERENCE TO RELATED APPLICATION

This application claims priority to and the benefit of Korean Patent Application No. 10-2007-0050389, filed on May 23, 2007, in the Korean Intellectual Property Office, the entire content of which is incorporated herein by reference.

### BACKGROUND

1. Field of the Invention

The present invention relates to a driving device and a driving method of a plasma display panel (PDP), and more particularly, to a driving device and a driving method of a PDP using an optimal correction value to efficiently control the voltage of an electrode driving signal with respect to the ambient temperature of the PDP.

2. Discussion of Related Art

Plasma display panels, which are relatively easy to manufacture in large-sizes, are flat panel display devices. Plasma display panels discharge through the voltage control applied between an address electrode, a scan electrode, and a sustain electrode of a discharge cell, constituting a pixel, and, by controlling the discharge period within the cell, light resulting from the discharge forms an image.

The entire screen image in the PDP is obtained by applying an addressing pulse for inputting a digital image signal into the address electrodes, the scan electrodes and the sustain electrodes of each cell, a reset pulse for scanning, a sustain pulse for maintaining discharge, and an erase pulse for stopping the discharge of the discharged cells and then driving them in a matrix type.

The gray levels required to display an image are expressed by varying the length of the time that each cell is discharged within a given amount of time ( 1/30 second in the case of a NTSC TV signal) to be differed from each other. The luminance of the screen is determined by the brightness when each cell is driven at maximum, and a driving circuit capable of maintaining the discharge time of the cell as long as possible should be designed in order to increase the brightness.

Contrast is determined by the difference in brightness between the background and the luminance, and the background should be dark and the luminance should be increased, in order to increase the contrast. In the case of a flat panel display device for an HDTV, 256 gray levels, a resolution of 1280×1024 or more, and a contrast of 100:1 or more under lighting of 200 lux, are required. Therefore, the image digital signal required for displaying an image of 256 gray levels requires an 8-bit signal of each RGB and maintains the discharge time of the cell as long as possible in order to obtain the required brightness and contrast. Methods for implementing the gray levels include a line scanning method and a subfield method. Three-electrode AC surface discharge type PDPs may use the subfield method.

For such PDPs, a three-electrode AC surface discharge type PDP driven by means of AC voltage, as shown in FIG. 1, is typical.

Referring to FIG. 1, the three-electrode AC surface discharge type PDP includes scan and sustain electrodes 12 formed on an upper substrate 10, and address electrodes 20 formed on a lower substrate 18. An upper dielectric layer 14 and a protective layer 16 are layered on the upper substrate 10, and the scan and sustain electrodes 12 are parallel. The upper dielectric layer 14 and the protective layer 16 separate the scan and sustain electrodes 12 from a discharge area to extend the life time of the cell and allow accumulation of charges within the cell, making it possible to lower the discharge voltage applied to an external electrode by using the charges within the discharge cell. A wall charge generated at the time of plasma discharge accumulates on the upper dielectric layer 14.

Further, the protective layer 16 prevents damage of the upper dielectric layer 14 due to sputtering generated at the time of plasma discharge and increases discharge efficiency of secondary electrons. Commonly, magnesium oxide (MgO) is used as the protective layer 16. A lower dielectric layer 22 and a barrier rib 24 are formed on the lower substrate 18 with the address electrode 20. A phosphor layer 26 is applied on the surface of the lower dielectric layer 22 and barrier ribs 24. The address electrode 20 crosses the scan electrode 12 and the sustain electrode 12.

The barrier rib 24 is parallel with the address electrode 20 so that ultraviolet rays and visible rays generated from the discharge do not leak to adjacent discharge cells. The phosphor layer 26 is excited by the ultraviolet rays generated by the plasma discharge and generates visible rays of either red (R), green (G), or blue (B). Inert gas for gas discharge is injected into discharge spaces provided between the upper substrate 10 and the lower substrate 18. In the case of the three-electrode AC surface discharge type PDP having such an electrode structure, an AC voltage, where polarity is continuously reversed, should be applied between the electrodes in order to maintain the discharge.

Referring to FIG. 2, first, the respective cells 11 are formed where scan electrodes Y1 to Ym and sustain electrodes X1 to Xn cross address electrodes A1 to An. The scan electrodes Y1 to Yn are used for scanning the screen, the sustain electrodes X1 to Xn are mainly used for maintaining the discharge, and the address electrodes A1 to Am are used for inputting data.

In order to accommodate a discharge characteristic deviation, a driving method of the plasma display panel that reduces power consumption and improves contrast by sensing ambient temperate and variably controlling the voltage level of the PDP driving signal with respect to the sensed temperature has been proposed in Korean Laid-Open Patent Publication No. 10-2004-0094147.

However, although the proposed method can reduce power consumption, it also degrades display quality. The cause of the degradation will be described later in the explanation of the present invention.

### SUMMARY OF THE INVENTION

An aspect of the present invention is directed toward a method of a driving PDP by applying a proper temperature correction value to a PDP driving signal.

An embodiment of the present invention provides a method of driving a plasma display panel by applying an electrode driving signal to the plasma display panel, the method including: obtaining a temperature of the plasma display panel; and generating the electrode driving signal, wherein: if the temperature is greater than a first reference temperature and less than a second reference temperature, generating the electrode driving signal having a first waveform, if the temperature is less than the first reference temperature, generating the electrode driving signal having a second waveform with an absolute value of at least one peak value being greater than that of a corresponding peak value of the first waveform, and if the temperature is greater than the second reference temperature, generating the electrode driving signal having a third waveform with an absolute value of at least one peak value being less than that of a corresponding peak value of the first waveform; wherein an absolute value of a difference between the at least one peak value of the second waveform and the corresponding peak value of the first waveform is larger than an absolute value of a difference between a corresponding peak value of the third waveform and a corresponding peak value of the first waveform.

The plasma display panel may include a scan electrode, a sustain electrode, and an address electrode, and the electrode driving signal may include a scan electrode driving signal, a sustain electrode driving signal, and an address electrode driving signal.

The electrode driving signal may include a waveform having a reset period, an address period, and a sustain period.

The at least one peak value may include a maximum potential of a ramp-up waveform of the scan electrode driving signal in the reset period.

The at least one peak value may include a minimum potential of a ramp-down waveform of the scan electrode driving signal in the reset period.

The at least one peak value may include a minimum potential of an addressing-down pulse waveform of the scan electrode driving signal in the address period.

The at least one peak value may include a maximum potential of an addressing-up pulse waveform of the address electrode driving signal in the address period.

In obtaining the temperature of the plasma display panel, a sensing value may be read from a temperature sensor mounted on the plasma display panel.

A plasma display panel including: a temperature obtaining unit for obtaining a temperature of the plasma display panel; an electrode driving signal generator for generating an electrode driving signal for the plasma display panel; and a temperature correcting unit for controlling the electrode driving signal generator to generate the electrode driving signal having: a first waveform, if the temperature is greater than a first reference temperature and less than a second reference temperature, a second waveform having an absolute value of at least one peak value being greater than a corresponding peak value of the first waveform, if the temperature is less than the first reference temperature, and a third waveform having an absolute value of at least one peak value being less than a corresponding peak value of the first waveform, if the temperature is greater than the second reference temperature, wherein in an absolute value of a difference between the at least one peak value of the second waveform and the corresponding peak value of the first waveform is larger than an absolute value of a difference between a corresponding peak value of the third waveform and a corresponding peak value of the first waveform.

The plasma display panel may include a scan electrode, a sustain electrode, and an address electrode, and the electrode driving signal generator may generate a scan electrode driving signal, a sustain electrode driving signal, and an address electrode driving signal.

The electrode driving signal generator may generate the electrode driving signal with a reset period, an address period, and a sustain period.

The at least one peak value may include a maximum potential of a ramp-up waveform of the scan electrode driving signal in the reset period.

The at least one peak value may include a minimum potential of a ramp-down waveform of the scan electrode driving signal in the reset period.

The at least one peak value may include a minimum potential of a addressing-down pulse waveform of the scan electrode driving signal in the address period.

The at least one peak value may include a maximum potential of an addressing-up pulse waveform of the address electrode driving signal in the address period.

The temperature obtaining unit may read a sensing value from a temperature sensor mounted on the plasma display panel.

The electrode driving signal generator may include a driver IC, and the temperature correcting unit may include a logic controller.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view showing a solid structure of a conventional three-electrode PDP discharge cell.

FIG. 2 is a schematic view of the PDP electrodes of FIG. 1.

FIG. 3 is a waveform view showing electrode driving signals for the electrodes of PDP.

FIG. 4 is a schematic view showing a distribution state of wall charges of a discharge cell when the electrode driving signals of FIG. 3 are applied to the PDP discharge cell.

FIG. 5A is a graph showing the relationship between a firing voltage and the pressure within a discharge cell.

FIG. 5B is a graph showing the relationship between firing voltage and temperature within a discharge cell.

FIG. 6 is a conceptual view showing distribution states of wall charges of discharge cells when an electrode driving signal is applied to the PDP discharge cells of FIG. 1 in states of normal temperature, high temperature, and low temperature.

FIG. 7 is a waveform view showing an embodiment of the present invention where an electrode driving signal has different waveforms, with respect to temperature, applied to the electrodes of PDP.

FIG. 8 is a schematic view showing a structure of a plasma display device according to an embodiment of the present invention.

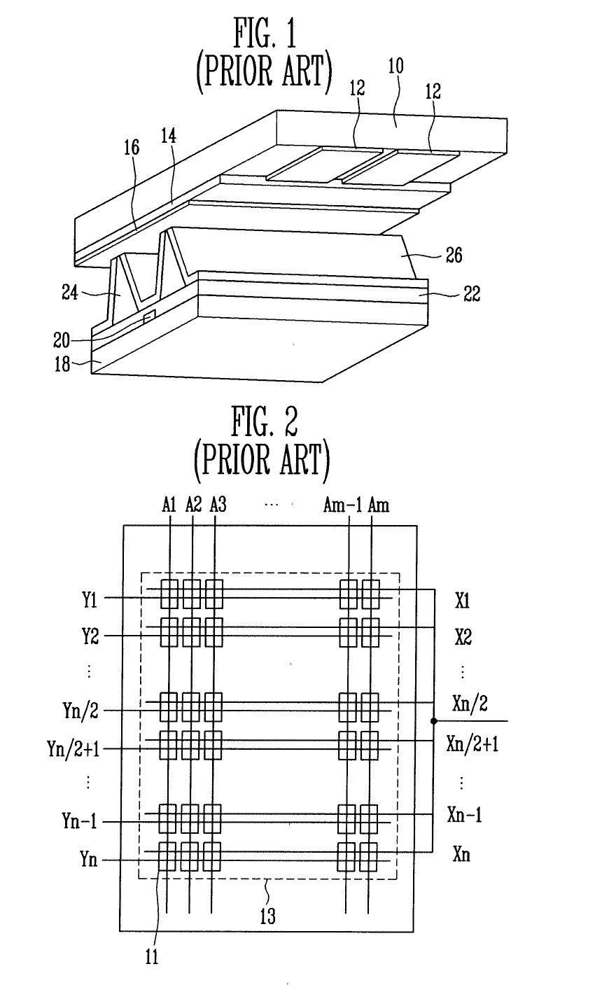

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

FIG. 3 shows PDP driving signal waveforms applied to a scan electrode Y, a sustain electrode X, and an address electrode A, where the waveforms have a fixed shape regardless of temperature.

The shown PDP driving signal includes a reset period, an address period, and a sustain period. Further, the reset period includes a reset-write period and a reset-erase period, and the PDP driving signal may also include an erase period prior to the reset period.

For the scan electrode driving signal, a ramp-up waveform is generated in the reset-write period and a ramp-down waveform is generated in the reset-erase period. Also, an addressing pulse is generated between the address electrode selected in the address period and the scan electrode, and an alternating sustain pulse between the scan electrode and the sustain electrode is generated in the sustain period.

However, when determining the driving voltage of a conventional plasma display panel, when the voltage level is once set at the voltage level capable of being satisfied at normal temperature and at high temperature, the voltage level remains fixed. However, the plasma display panel mostly operates under a high temperature environment, and a wall charge within the cell used in driving the plasma display panel is greatly affected by the temperature.

As the time of use elapses, the ambient temperature of the plasma display panel rises, and the wall charges within the cell become more mobile so that the plasma display panel needs a higher ramp-up voltage and addressing voltage in order to control the wall charges. Therefore, when the driving voltage applied is below the driving voltage level required at high temperatures, the plasma display panel may erroneously not discharge a cell that should be discharged. Resultingly, the driving voltage of the plasma display panel is conventionally preset at a voltage level capable of operating at high temperature.

However, because high power consumption occurs due to the driving voltage level being set for a high temperature and a high level of set-up discharge occurring at the time of resetting, deterioration of contrast occurs in the normal temperature operation environment.

Referring to FIG. 3, in the prior art, Korean Laid-Open Patent Publication No. 10-2004-0094147 describes that, for example, if a peak voltage Vsetup of a ramp-up waveform and a peak voltage Va of a pulse for address-on in the address electrode are set corresponding to the normal temperature environment and the high temperature environment, respectively, a peak voltage Vsetup of a ramp-up waveform of a scan electrode Y at normal temperature is set to be lower than that at high temperature, and a peak voltage Va of a pulse for address-on in a scan electrode at normal temperature is also set to be lower than that at high temperature.

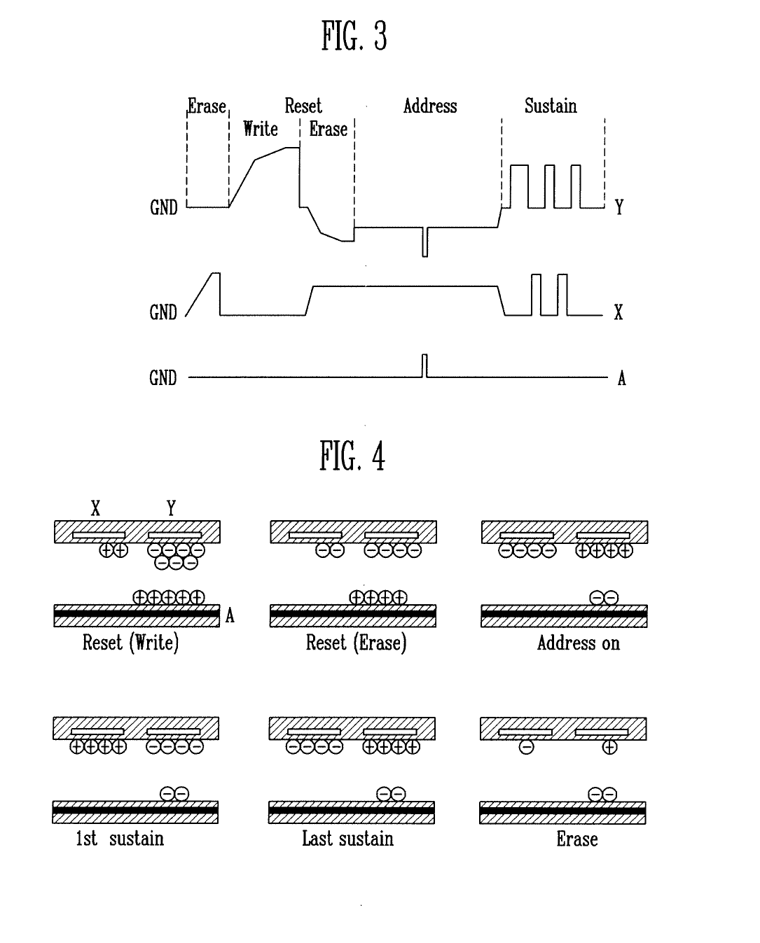

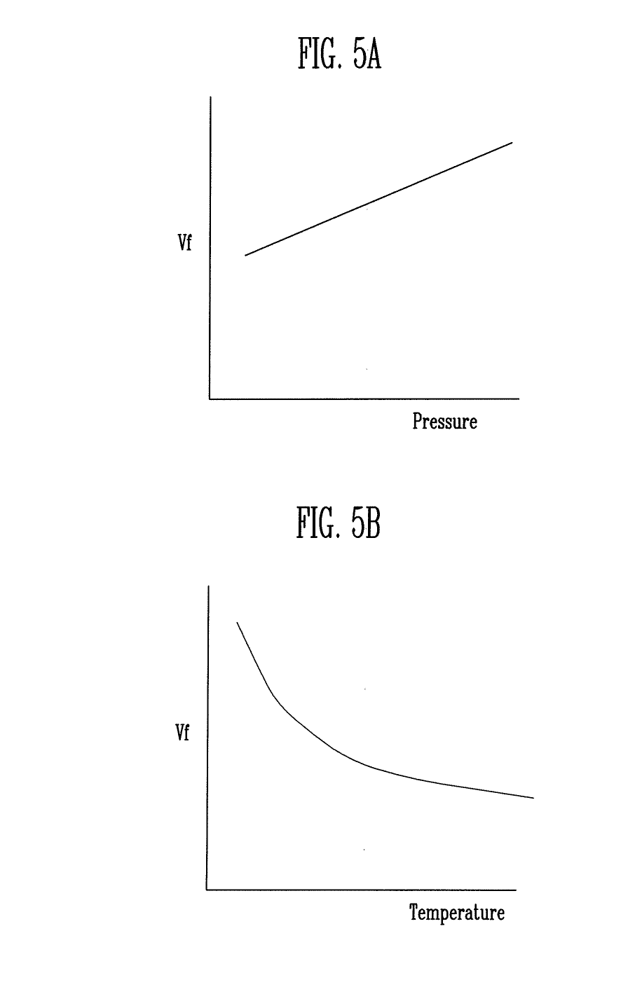

FIG. 4 shows the state of wall charges when a plasma display panel is driven at normal temperature with electrode driving signals, as shown in the FIG. 3.

A PDP electrode driving signal includes the waveform periods referred to as reset/address/sustain/erase, wherein the reset period is divided into a reset-write period for which a ramp-up waveform is generated and a reset-erase period for which a ramp-down waveform is generated. First, the change of the wall charges of a discharge cell in each period will be described for the waveform of the PDP electrode driving signal at the normal temperature.

In the reset-write period, discharge is first generated between an address electrode and a scan electrode with a low firing voltage. When the voltage value of the ramp-up waveform becomes larger than the firing voltage between the address electrode and the scan electrode, electrons accumulate on the scan electrode, and ions accumulate on the address electrode. In the ramp-up period, the scan electrode is an anode, and the sustain electrode is a cathode. Wall voltages are formed on the scan electrode and the address electrode from the electrons and the ions, respectively.

Hereinafter, the wall voltages formed on the scan electrode and the address electrode will be referred to as Vw(Y) and Vw(A), respectively. Since the wall voltages formed on the scan electrode and the address electrode hinder discharge between the scan electrode and the address electrode, when the wall voltages are formed on the address electrode and the scan electrode, the discharge does not occur for a while.

In the ramp-up period, since the voltage applied to the scan electrode continuously increases, discharge occurs when Equation 1 is satisfied.

Vext (voltage applied to Y electrode)>Vf+Vw(Y)+Vw(A) (where Vf is firing voltage.) Equation 1

More charges are accumulated on the scan electrode and the address electrode due to the re-discharging, so that wall voltages accumulate on the scan electrode and the address electrode. The wall voltages accumulated on the scan electrode and the address electrode hinder discharge. Here, charge has not yet accumulated on the sustain electrode so that an actual voltage between discharge electrodes is described by Equation 2.

Between address electrode and scan electrode: Vext−Vw(Y)−Vv(X)=Vgap(A−Y).

Between sustain electrode and scan electrode: Vext−Vw(Y)=Vgap(X−Y). Equation 2

Although Vf(X−Y)>Vf(A−Y), as the charges accumulate on the scan electrode and the address electrode, Vgap(X−Y) becomes larger than Vgap(A−Y). Therefore, the discharge between the sustain electrode and the scan electrode occurs when (Vext−Vw(Y)=Vgap(X−Y))>Vf(X−Y). As a result, ions begin to accumulate on the sustain electrode and more electrons accumulate on the scan electrode.

Therefore, when the ramp-up period ends, electrons are accumulated on the scan electrode and ions are accumulated on the address electrode. At this time, the number of the ions accumulated on the address electrode is larger than that of the number of ions accumulated on the sustain electrode, because Vf(A−Y)<Vf(X−Y). That is, when the Vext is the same, more charges are accumulated when the firing voltage is relatively low, so that Vw becomes large.

In the reset-erase period, a ramp-down waveform with a negative polarity is applied to the scan electrode, a positive bias (Vbias) is applied to the sustain electrode, and the address electrode maintains ground potential. The wall voltage (Vw) hinders discharge in the ramp-up period, while encouraging discharge in the ramp-down period.

When Vbias(X)−Vext(Y)>Vf(X−Y)−Vw(X)−Vw(Y), discharge occurs between the sustain electrode and the scan electrode, so that electrons and ions accumulated on the scan electrode and the sustain electrode, respectively, are erased. After ions accumulated on the sustain electrode are erased, electrons then accumulate on the sustain electrode. The electrons accumulated on the scan electrode are erased and the ions are accumulated on the sustain electrode, so the discharge between the scan electrode and the address electrode occurs more easily than the discharge between the scan electrode and the sustain electrode (although the voltage applied to the sustain electrode is larger than the voltage applied to the address electrode). At this time, a portion of the electrons and ions accumulated on each of the scan electrode and the address electrode is erased. As a result, electrons accumulate on the scan electrode and the sustain electrode, and ions ccumulate on the address electrode. At this time, the amount of electrons accumulated on the scan electrode is greater than the amount of electrons accumulated on the sustain electrode.

In the address period, an addressing-down pulse (Vscan) in a negative direction is applied to the scan electrode, and an addressing-up pulse (Vadd) in a positive direction is applied to a selected address electrode. In this case, if Vadd+Vscan>Vf(A−Y)−Vw(A)−Vw(Y) is satisfied, address discharge occurs.

A discharge in the address period is initiated between the address electrode and the scan electrode, and then occurs between the sustain electrode and the scan electrode. Consequently, a charge state for sustain discharge is formed, as shown in ‘address on’ in FIG. 4. Then, in the sustain period (‘1st sustain’ and ‘last sustain’ in FIG. 4), the sustain discharge, similar to the address discharge, is repeatedly performed in the discharge cells in which there was an address discharge.

Here, the method according to one embodiment of the present invention for finding the optimal correcting value for the panel driving signal depending on the temperature of the display panel will be described.

It is well-known in the art that as pressure increases, firing voltage becomes higher, under the same electrode gap (Paschen's law). This is because, as the pressure increases, density is increased, and as the density increases, interaction between gas species or charged species increases.

Ions must be generated to generate the discharge. Ions are generated by an impact of a portion of electrons with energy higher than ionization energy and neutral gas. Therefore, there must be a large number of high energy electrons to generate a large number of ions. However, if the density becomes large, the impact of the electrons and the neutral gas increases so that the probability that the electrons will be sufficiently accelerated by an electric field is low. Consequently, the processes of: the increase of the pressure→the increase of the density→the increase of the impact of the electrons and the gas species→the reduction of the ratio of the electrons with high energy→the reduction of the number of ions generated→the increase of the firing voltage, are caused.

The pressure and volume of discharge gas is constant within each discharge cell of the PDP. However, the temperature of the display panel is influenced by ambient temperature. If the temperature varies when the pressure and volume is constant, the density varies as described below in Equation 3.

P=nRT(P: pressure, n: density, and T: temperature) Equation 3

Here, while Vf, which proportional to the density, is linearly increased depending on the pressure, it is linearly increased depending on 1/T in temperature. Accordingly, while the relationship between the firing voltage and pressure in the discharge cell is linear, as shown in FIG. 5A, the relationship between firing voltage and temperature in the discharge cell is a function of Vf=1/T, as shown in FIG. 5B.

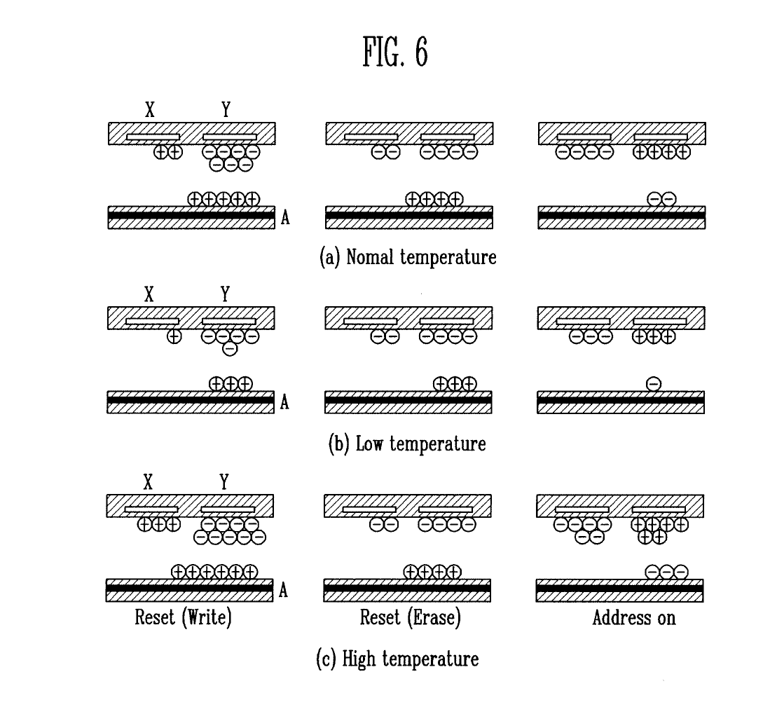

As shown in FIG. 6, the distribution of wall charges depends on temperature variation when the same electrode driving signal waveform is used. As temperature decreases, the firing voltage increases. Therefore, discharge is generated later in the ramp-up period, so the wall charge accumulated is reduced. Alternatively, as the temperature decreases, the wall charge erased in the ramp-down period is reduced. Consequently, the difference in the wall charge accumulated on each electrode after the ramp-down period is not large.

In one embodiment, a necessary and sufficient condition for generating the address discharge is that Vadd+Vscan>Vf(A−Y)−Vw(A)−Vw(Y), as described above.

Since the firing voltage between the address electrode A and the scan electrode Y is inversely proportional to the temperature, the wall voltage after the address discharge depends on the temperature. That is, as the temperature decreases, a wall voltage (Vw) formed between the sustain electrode and the scan electrode decreases, and as the temperature increases, a wall voltage (Vw) formed between the sustain electrode and the scan electrode increases.

The wall charge after ‘Address on’, as shown in the FIG. 6, depicts a small wall voltage (Vw) on the sustain electrode and scan electrode for low temperature, in which the firing voltage is high, and a large wall voltage (Vw) on the sustain electrode and the scan electrode for high temperature, in which the firing voltage is low. Therefore, conventionally as in art (2004-94147) described above, when generating the electrode driving signal having a high peak for high temperature, the discharge deviation depending on the temperature is increased.

An exemplary embodiment of the present invention improves the quality of display by suppressing discharge deviation resulting from temperature variation of the display panel. In order to control proper turn-on and turn-off of the discharge cell, a large wall voltage (Vw) must be formed in the low temperature environment, in which the firing voltage (Vf) is high, and a small wall voltage (Vw) must be formed in the high temperature environment, in which the firing voltage (Vf) is low, after the address discharge.

There are four schemes for accomplishing this result, wherein one or more schemes are applied so that discharge characteristics can be improved. Here, it is preferable that the levels of the sustain voltage are the same in the low temperature, the normal temperature, and the high temperature, as in the conventional art.

Scheme 1: When applying offset voltage as a correction value, with respect to temperature, to a peak voltage value of the ramp-up waveform, the relationship of V_H>V_M>V_L is satisfied (where V_H=low temperature; V_M=normal temperature; V_L=high temperature). In addition, since Vf is proportional to 1/T, |V_H−V_M|>|V_M−V_L| is satisfied.

Scheme 2: When applying offset voltage as a correction value, with respect to temperature, to a peak voltage value of the ramp-down waveform, the relationship of V_H<V_M<V_L is satisfied (where, V_H: low temperature/V_M: normal temperature/V_L: high temperature). In addition, since Vf is proportional to 1/T, |V_H−V_M|>|V_M−V_L| is satisfied.

Scheme 3: When applying offset voltage as a correction value, with respect to temperature, to the peak voltage value of the pulse applied to the scan electrode in the address-on operation performed for discharge cells selected in the address period, the relationship of V_H<V_M<V_L is satisfied (where, V_H: low temperature/V_M: normal temperature/V_L: high temperature). In addition, since Vf is proportional to 1/T, |V_H−V_M|>V_M−V_L| is satisfied.

Scheme 4: When applying offset voltage as a correction value, with respect to temperature, to the peak voltage value of the pulse applied to the address electrode in the address-on operation performed for discharge cells selected in the address period, the relationship of V_H>V_M>V_L is satisfied (where, V_H: low temperature/V_M: normal temperature/V_L: high temperature). In addition, since Vf is proportional to 1/T, |V_H−V_M|>|V_M−V_L| is satisfied.

Thus, the method of the present invention provides an offset voltage to the peak value (i.e., the maximum or minimum value in a period (that may be predetermined) of the waveform) of the electrode driving signal, with respect to a unit temperature variation (that may be predetermined) for the PDP, wherein as the temperature decreases, the absolute value of the offset voltage, with respect to the unit temperature difference, increases. For example, assuming that the normal temperature is 20° C. to 25° C. and the unit temperature difference is 5° C., the maximum value of the ramp-up pulse in the reset period becomes T1 at 12° C., T2 at 17° C., T3 at 22° C., T4 at 27° C., and T5 at 32° C. Here, T1>T2>T3>T4>T5, |T1−T2|>|T2−T3|>|T3−T4|>|T4−T5|. Thus, |T1−T2|, |T2−T3|, |T3−T4|, and |T4−T5| are increments of the absolute value of the offset depending on the unit temperature difference.

If these are applied by being divided into three temperature grades, that is, the high temperature, the low temperature, and the high temperature, when the obtained temperature of the PDP is higher than a first reference temperature (that may be predetermined) and lower than a second reference temperature (that may be predetermined), the PDP is driven by an electrode driving signal with a first waveform (normal temperature waveform). When the temperature of the PDP is lower than the first reference temperature, the PDP is driven by an electrode driving signal with a second waveform (low temperature waveform), larger in absolute value of the peak values of first electrode driving signal. When the temperature of the PDP is higher than the second reference temperature, the PDP is driven by an electrode driving signal with a third waveform (high temperature waveform), smaller in absolute value of the peak values than the first electrode driving signal. Here, the normal temperature is a temperature between the first reference temperature and the second reference temperature, with the first reference temperature being lower than the second reference temperature.

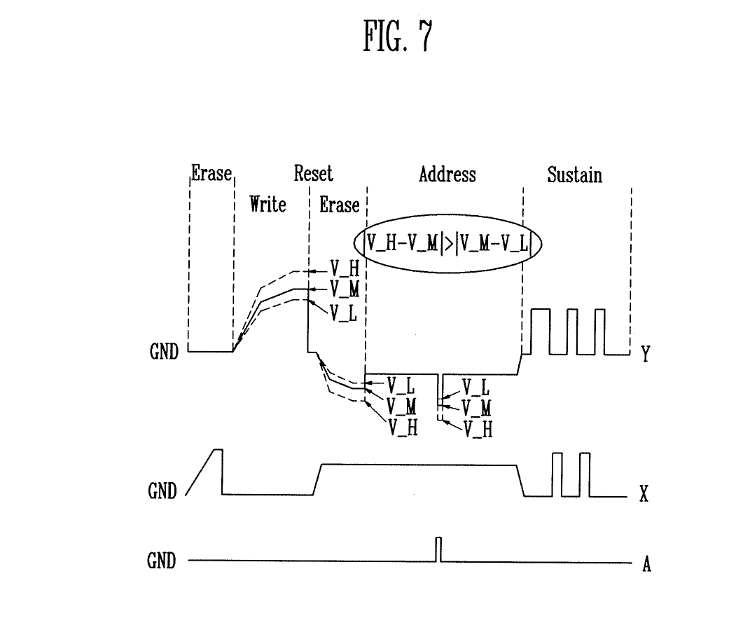

FIG. 7 shows a waveform of a panel driving signal according to one embodiment of the present invention. Here, the application of schemes 1 to 3 is shown.

First, the temperature of the display panel must be obtained. The temperature of the display panel may be directly measured from a temperature sensor installed to contact the display panel or a point having a substantially similar temperature to the display panel, or current and voltage consumed in the panel can be estimated from the measured value.

The temperature may be obtained for the corresponding time point for one picture frame or the corresponding time point for one sub-field.

As shown in the FIG. 7, the electrode driving signals are applied to the scan electrode Y, the sustain electrode X, and the address electrode A, wherein the period for applying the respective electrode driving signals are divided into the erase period, the reset period, the address period, and the sustain period.

The PDP electrode driving signal is generally generated in each driver IC, according to the timing control signal output from a logic controller, and thus, the electrode driving signal can be generated by the same process. Here, changing the peak voltage, according to the method of the present invention, can be implemented by inputting separate temperature indication data to each driver IC.

The change of the peak voltage within each driver IC can be made by receiving or internally generating a plurality of peak voltage levels or connecting at a proper peak voltage level, or a controlling the peak voltage level by changing the capacity of the condenser (e.g., capacitor or inductor) used for the generation of the waveform, in the case of the ramp waveform.

In FIG. 7, the level of the middle absolute value V_M is applied to the electrode driving signal when the temperature of the display panel is a room operating temperature. Also, the level of the large absolute value V_H is applied to the electrode driving signal when the temperature of the display panel is lower than room operating temperature by a threshold value (that may be predetermined). The level of the small absolute value V_L is applied to the electrode driving signal when the temperature of the display panel is higher than normal operating temperature by a threshold value (that may be predetermined).

The gap between the V_H signal and the V_M signal is wider than the gap between the V_M signal and the V_L signal, so that the relationship of |V_H−V_M|>|V_M−V_L| is satisfied for each peak.

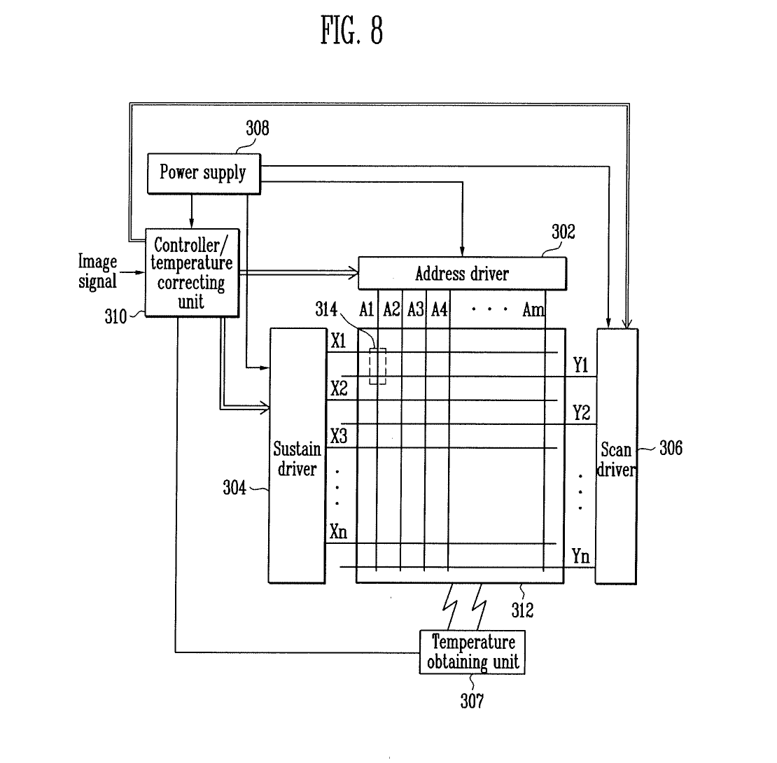

FIG. 8 is a schematic view showing a plasma display device according to the embodiment of the present invention.

Referring to the FIG. 8, the plasma display device, according to an embodiment of the present invention, includes a plasma display panel 312, an address driver 302, a sustain driver 304, a scan driver 306, a power supply 308, a temperature obtaining unit 307, and a controller/temperature correcting unit 310.

The plasma display panel 312 includes scan electrodes Y1 to Yn and sustain electrodes X1 to Xn, substantially parallel to each other, and address electrodes A1 to Am crossing the scan electrodes Y1 to Yn. Here, discharge cells 314 are located where scan electrodes Y1 to Yn and sustain electrode X1 to Xn cross address electrodes A1 to Am. The structure of electrodes Y, X, and A forming the discharge cell 314 are only an example, and the present invention is not limited thereto.

The temperature obtaining unit 307 may be a temperature sensor mounted on the plasma display panel 312 or located at a point where the temperature varies in accordance with the temperature of the plasma display panel 312. Alternatively, a calculating module may estimate the temperature from the consumed current and voltage of the plasma display panel 312. The temperature value obtained from the temperature obtaining unit 307 is input into the controller/temperature correcting unit 310.

The controller/temperature correcting unit 310 receives an externally provided image signal and generates control signals for controlling the address driver 302, the sustain driver 304, and the scan driver 306. Here, the controller/temperature correcting unit 310 generates the control signals so that one frame can be driven by being divided into a plurality of sub-fields having a reset period, an address period, and a sustain period.

The controller/temperature correcting unit 310 applies the temperature control signals, with respect to the temperature value received from the temperature obtaining unit 307, to at least one of the address driver 302, the scan driver 306, and the sustain driver 304. The driver receiving the temperature control signal supplies an electrode driving signal corresponding to the potential of a smaller absolute value in the case where the obtained temperature is a high temperature, and supplies the electrode driving signal corresponding to the potential of a larger absolute value in the case where the obtained temperature is a low temperature.

The controller/temperature correcting unit 310 can be controlled by a logic controller when it is applied to the general structure of the PDP device. Although the temperature correcting unit 310 may be controlled by a separate device from the controller, manufacturing costs may be lower when the controller/temperature correcting unit 310 is incorporated as shown.

The PDP device includes the address driver 302, the sustain driver 304, and the scan driver 306 as electrode driving signal generators generating the electrode driving signals. The address driver 302 supplies an addressing-up pulse to the address electrodes A1 to Am during the address period of each sub-field, corresponding to the control signal supplied from the controller 310 to select the discharge cells 314. The address driver 302 can be implemented as an address electrode driver IC in the case where it is applied to the general structure of the PDP device.

The sustain driver 304 supplies a repeated sustain pulse to the sustain electrodes X1 to Xn during the sustain period of each sub-field, corresponding to the control signal supplied from the controller 310. The sustain driver 304 can be implemented as a sustain electrode driver IC in the case where it is applied to the general structure of the PDP device.

The scan driver 306 supplies a scan electrode driving signal to the scan electrodes Y1 to Yn, corresponding to the control signal supplied from the controller 310. Thus, the scan driver 306 supplies the ramp-up waveform and the ramp-down waveform to the scan electrodes Y1 to Yn so that wall charges required for the sustain discharge are formed during the reset period of each sub-field, and sequentially supplies the addressing-down pulse having a negative polarity during the address period. Also, the scan driver 306 supplies a sustain pulse that is repeatedly alternated with the sustain electrode X1 to Xn during the sustain period of each sub-field. The scan driver 306 can be implemented as a scan electrode driver IC in the case where it is applied to the general structure of the PDP device.

At least one of the addressing-up pulse of the address electrode driving signal generated from the address driver 302, and the ramp-up waveform, the ramp-down waveform, and the address-down pulse the scan electrode driving signal generated from the scan driver 306 can vary in peak value level thereof according to the control of the temperature correcting unit.

The power supply 308 supplies the power required for driving the plasma display panel 312 to the controller 310 and the drivers 302, 304, and 306.

The driving device and method of the plasma display panel in one embodiment according to the present invention according to the constitution described above are practiced to be able to ensure a stable quality of display even in the temperature variation of the plasma display panel.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method of driving a plasma display panel by applying an electrode driving signal to the plasma display panel, the method comprising:
obtaining a temperature of the plasma display panel; and
generating the electrode driving signal, wherein:
if the temperature is greater than a first reference temperature and less than a second reference temperature, generating the electrode driving signal having a first waveform,
if the temperature is less than the first reference temperature, generating the electrode driving signal having a second waveform with an absolute value of at least one peak value being greater than that of a corresponding peak value of the first waveform, and
if the temperature is greater than the second reference temperature, generating the electrode driving signal having a third waveform with an absolute value of at least one peak value being less than that of a corresponding peak value of the first waveform;
wherein an absolute value of a difference between the at least one peak value of the second waveform and the corresponding peak value of the first waveform is larger than an absolute value of a difference between a corresponding peak value of the third waveform and a corresponding peak value of the first waveform.

2. The method of driving the plasma display panel as claimed in claim 1, wherein the plasma display panel comprises a scan electrode, a sustain electrode, and an address electrode, and
the electrode driving signal comprises a scan electrode driving signal, a sustain electrode driving signal, and an address electrode driving signal.

3. The method of driving the plasma display panel as claimed in claim 2, wherein the electrode driving signal comprises a waveform having a reset period, an address period, and a sustain period.

4. The method of driving the plasma display panel as claimed in claim 3, wherein the at least one peak value comprises a maximum potential of a ramp-up waveform of the scan electrode driving signal in the reset period.

5. The method of driving the plasma display panel as claimed in claim 3, wherein the at least one peak value comprises a minimum potential of a ramp-down waveform of the scan electrode driving signal in the reset period.

6. The method of driving the plasma display panel as claimed in claim 3, wherein the at least one peak value comprises a minimum potential of an addressing-down pulse waveform of the scan electrode driving signal in the address period.

7. The method of driving the plasma display panel as claimed in claim 3, wherein the at least one peak value comprises a maximum potential of an addressing-up pulse waveform of the address electrode driving signal in the address period.

8. The method of driving the plasma display panel as claimed in claim 1, wherein in obtaining the temperature of the plasma display panel, a sensing value is read from a temperature sensor mounted on the plasma display panel.

9. A plasma display panel comprising:
a temperature obtaining unit for obtaining a temperature of the plasma display panel;
an electrode driving signal generator for generating an electrode driving signal for the plasma display panel; and
a temperature correcting unit for controlling the electrode driving signal generator to generate the electrode driving signal having:
a first waveform, if the temperature is greater than a first reference temperature and less than a second reference temperature,
a second waveform having an absolute value of at least one peak value being greater than a corresponding peak value of the first waveform, if the temperature is less than the first reference temperature, and
a third waveform having an absolute value of at least one peak value being less than a corresponding peak value of the first waveform, if the temperature is greater than the second reference temperature,
wherein in an absolute value of a difference between the at least one peak value of the second waveform and the corresponding peak value of the first waveform is larger than an absolute value of a difference between a corresponding peak value of the third waveform and a corresponding peak value of the first waveform.

10. The plasma display panel as claimed in claim 9, wherein the plasma display panel comprises a scan electrode, a sustain electrode, and an address electrode, and
the electrode driving signal generator generates a scan electrode driving signal, a sustain electrode driving signal, and an address electrode driving signal.

11. The plasma display panel as claimed in claim 10, wherein the electrode driving signal generator generates the electrode driving signal with a reset period, an address period, and a sustain period.

12. The plasma display panel as claimed in claim 11, wherein the at least one peak value comprises a maximum potential of a ramp-up waveform of the scan electrode driving signal in the reset period.

13. The plasma display panel as claimed in claim 11, wherein the at least one peak value comprises a minimum potential of a ramp-down waveform of the scan electrode driving signal in the reset period.

14. The plasma display panel as claimed in claim 11, wherein the at least one peak value comprises a minimum potential of a addressing-down pulse waveform of the scan electrode driving signal in the address period.

15. The plasma display panel as claimed in claim 11, wherein the at least one peak value comprises a maximum potential of an addressing-up pulse waveform of the address electrode driving signal in the address period.

16. The plasma display panel as claimed in claim 9, wherein the temperature obtaining unit reads a sensing value from a temperature sensor mounted on the plasma display panel.

17. The plasma display panel as claimed in claim 9, wherein the electrode driving signal generator comprises a driver IC, and
the temperature correcting unit comprises a logic controller.
